(19) United States
(12) Patent Application Publication
(10) Pub. No.: US 2011/0012827 A1
(43) Pub. Date: Jan. 20, 2011

(54) Motion Mapping System

(76) Inventors: Zhou Ye, Foster City, CA (US); Shun-Nan Liou, Kaohsiung City (TW); Ying-Ko Lu, Taoyuan County (TW); Ching-Lin Hsieh, Taoyuan County (TW); Pai-Sung Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/647,397

(22) Filed: Dec. 25, 2009

Related U.S. Application Data
(60) Provisional application No. 61/225,555, filed on Jul. 14, 2009.

(51) Int. Cl. G06F 3/01; G06F 13/14

(52) U.S. Cl. 345/156; 710/305

(57) ABSTRACT

A motion mapping system includes a motion sensing device and a receiving device. The motion sensing device may include an accelerometer, a rotational sensor, a microcontroller, and an RF transmitter. The microcontroller may output processed motion data to the receiving device. The receiving device may include an RF receiver, a microprocessor, and a Universal Serial Bus interface for connection to a computer. The receiving device's microprocessor may output the processed motion data to motion mapping software. The motion mapping software may map the motion data to a corresponding predetermined input event defined by the motion mapping software and transmit a control signal back to the receiving device's microprocessor indicating the corresponding predetermined input event. Upon reception of the control signal from the mapping software, the receiving device's microprocessor may generate a hardware input event according to the control signal and transmits the generated hardware input event back to the computer.

### BACKGROUND OF THE INVENTION

1. Field of the Invention

The present application relates to a wireless motion mapping system, and more specifically to a wireless motion mapping system capable of generating user defined hardware input events.

2. Description of the Prior Art

Software applications like a video game for a PC (as opposed to a dedicated game machine) or presentation tool usually work with a conventional input device, such as a mouse, keyboard, touchpad, or joystick. Using the conventional input devices may not simulate the player's actions in the real life, such as swinging a tennis racket or driving a golf club. Additionally, in some video games, some of the avatars' actions need complex combinations of keystrokes to perform, for example multiple keys may need to be pressed at the same time or pressed in a specific time order. Moreover, the pressing time period of a key in a keystroke combination may be an issue in playing the PC video game.

Therefore, there is a need to provide a mapping tool for playing a PC video game using motions of a player's body to increase realism and/or for simplifying the arduous keystroke combinations often used in the PC video game or presentation tool.

### SUMMARY OF THE INVENTION

A motion mapping system includes a motion sensing device and a receiving device. The motion sensing device may include an accelerometer, a rotational sensor, a microcontroller, and an RF transmitter. A microcontroller of the motion sensing device may calibrate and/or perform other processing on the received acceleration and angular speed data and output processed motion data to the RF transmitter for transmission to the receiving device. The receiving device may include an RF receiver, a microprocessor, and a Universal Serial Bus interface for connection to an external device such as a computer. The receiving device's microprocessor receives the processed motion data and outputs the processed motion data to a motion mapping software. The motion mapping software maps the received motion data to a corresponding predetermined input event preferably user defined by the motion mapping software. Once the received motion data has been mapped to the corresponding predetermined input event, the motion mapping software transmits a control signal back to the receiving device's microprocessor indicating the corresponding predetermined input event. Upon reception of the control signal from the mapping software, the receiving device's microprocessor generates a hardware input event according to the control signal and transmits the generated hardware input event back to the computer.

A method of operating a motion mapping system includes transmitting motion data from a motion sensing device having an accelerometer and a rotational sensor to a receiving device. The receiving device transmits the motion data to motion mapping software which determines the input event corresponding to the motion data and transmits a control signal indicating the corresponding input event back to the receiving device. A microprocessor of the receiving device generates a hardware input event of a type corresponding to the control signal and transmits the hardware input event back an operating system of the computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a motion mapping system according to an embodiment of the present invention;

FIG. 2 is a diagram illustrating possible mode categories of the motion sensing device in FIG. 1;

FIG. 3 is a diagram illustrating a setup interface for forming mappings between sensed motions and generated hardware events according to an example of the present invention;

FIG. 4 is a flow chart illustrating usage of the motion mapping system in FIG. 1; and

FIG. 5 is a diagram illustrating mapping examples according to other examples of the present invention.

### DETAILED DESCRIPTION

A mapping tool of the present invention may allow complicated keystrokes or mouse clicks, from a game player's point of view, to be replaced by natural body motions of the game player, such as a forward thrust, rotation, and/or up/down or lateral movements, which may not only reduce the time for the game player to learn the control of the PC video game, but also increase realism, and allow the player to concentrate on the game, rather than having to remember the definition of keystroke combinations for controlling the action of an avatar in the game.

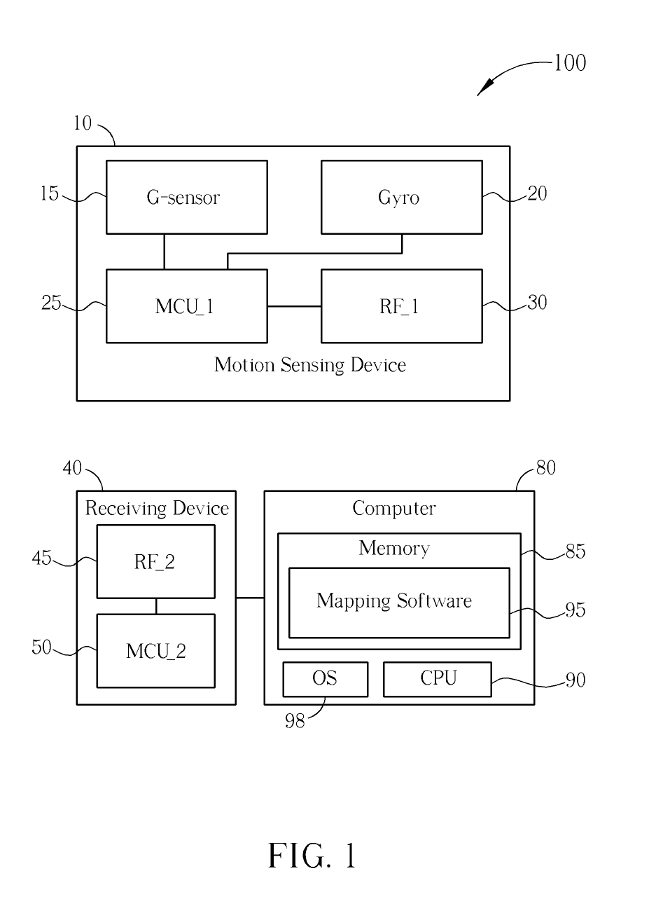

FIG. 1 is a block diagram illustrating a motion mapping system 100 according to an embodiment of the present invention. Referring to FIG. 1, the motion mapping system 100 may include a motion sensing device 10 and a receiving device 40. The motion sensing device 10 may include an accelerometer (G-sensor) 15, a rotational sensor (Gyro) 20, a microcontroller (MCU_1) 25, and possibly an RF transmitter (RF_1) 30. The accelerometer 15 may sense acceleration along one or more axes and outputs corresponding acceleration data to the microcontroller 25. The rotational sensor 20 preferably may be a gyroscope sensing angular speed along one or more axes and, outputting corresponding angular speed data to the microcontroller 25. The microcontroller 25 may calibrate and/or perform other processing, such as analog to digital conversion, on the received acceleration and angular speed data and output processed motion data to the RF transmitter 30 for transmission to the receiving device 40.

The receiving device 40 may include an RF receiver (RF_2) 45, a microprocessor (MCL_2) 50, and possibly a Universal Serial Bus (USB) interface for connection to an external device such as the computer 80 shown in FIG. 1. In some embodiments the receiving device 40 may be physically a part of the computer 80 where the USB interface, the RF transmitter 25, and the RF receiver 45 may not be necessary. The RF receiver 45 may receive the processed motion data transmitted from the RF transmitter 30 and output the received processed motion data to the microprocessor 50. The microprocessor 50 causes the processed motion data to be input to a motion mapping software 95 which may be in the memory 85 and executed by the CPU 90 of the external computer 80. The motion mapping software 95 may map the received motion data to a corresponding predetermined input event defined by the motion mapping software 95 and stores the correspondences for reference during game play via a lookup table, database, or other means. In some embodiments, the motion mapping software 95 may be operated within a memory of the receiving device 40 and under control of the microprocessor 50. However, preferred embodiments may utilize the external computer 80 to store and operate the motion mapping software 95. Some advantages of having the external computer 80 to store and operate the motion mapping software 95 may include use of the already existing memory 85 and superior speed, accuracy, sensitivity, and performance of the CPU 90 compared to the microprocessor 50.

During use of the motion mapping system 100 and once the received motion data has been mapped to the corresponding predetermined input event, in response to received motion data the motion mapping software 95 may transmit a control signal back to the microprocessor 50 of the receiving device 40 indicating the correspondingly mapped input event. Upon reception of the control signal from the mapping software 95, the microprocessor 50 may generate a hardware input event according to the control signal and may transmit the generated hardware input event to the computer 80. The generated hardware input event corresponds to the mapped input event defined by the motion mapping software such an the operating system 98 being executed by the CPU 90 recognizes the generated hardware input event similarly to recognition of a hardware input event generated by conventional input devices like a keyboard, mouse, joystick, touchpad, and similar input devices. It is preferred (but not necessary) that all embodiments generate a hardware input event rather than a virtual input event to maximize compatibility with application software that may not recognize a virtual input event.

It may be preferred that before using the motion mapping system 100, a user may access a suitable interface of the motion mapping software 95 and define how the motion mapping software 95 is to map received motion data to corresponding input events required by a game or application. For example, when playing a car racing game, it may be desirable to hold a steering wheel and steer the aviator's car left or right according to motion of the steering wheel. The motion mapping system 10 may recognize the rotational data generated by the user's “steering” left or right of the motion sensing device 10 and translate the left and/or right motions into the specific hardware events expected by the game to steer left and/or right, perhaps expected by the game to be presses of left and/or right arrow keys on the computer's keyboard.

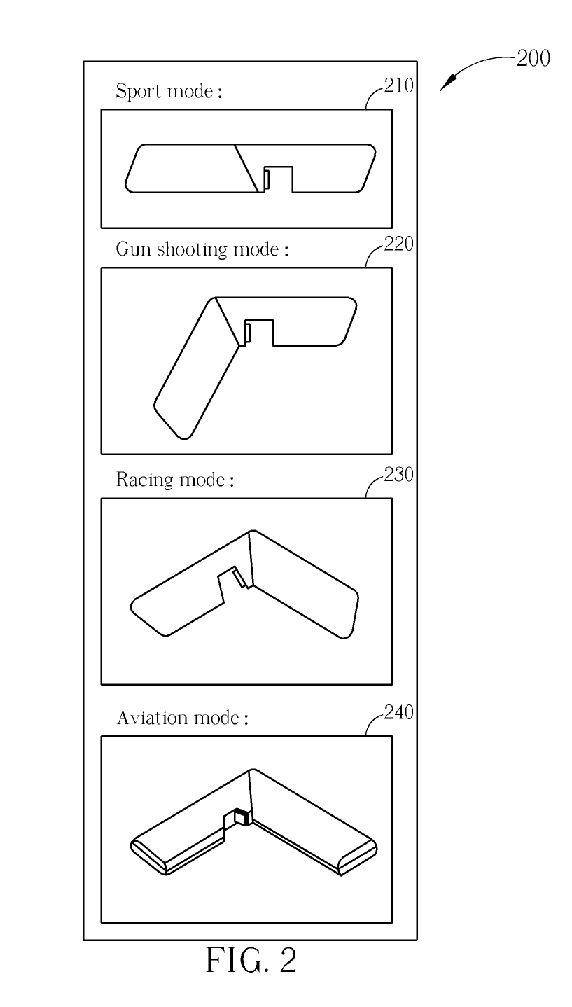

FIG. 2 is a diagram illustrating possible mode categories of the motion sensing device 10 in FIG. 1. Referring to FIG. 2, the motion sensing device 10 may come in various shapes and sizes, and may be configurable or adjustable. In one example, a motion sensing device 200 may be configured to at least one of the follow configurations: a sport mode 210, a gun shooting mode 220, a racing mode 230, and an aviation mode 240 to enhance the game playing experience. For example, the gun shooting mode 220 may allow a user to point and shoot the motion sensing device 200 may be similar to the way a user wield a gun.

Therefore, the motion mapping software 95 may provide a setup interface 300 to define mapping between the received motion data and the generated input events.

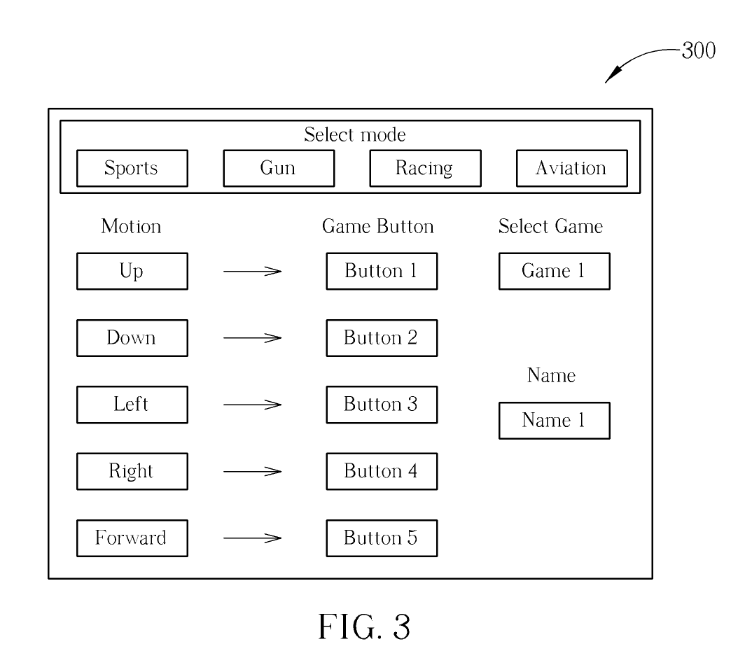

FIG. 3 is a diagram illustrating a setup interface 300 for forming mappings between sensed motions and generated hardware events according to an example of the present invention. Referring to FIG. 3, the setup interface 300 may allow a user to select the desired playing mode. Selection of playing mode may allow calibration of motion data to reflect intended orientation of the motion sensing device 10, as well as allow a plurality of mappings (one for each mode) for each movement sensed by motion sensing device 10. A different number of playing modes and/or motions may be present in various embodiments as well as game and/or name inputs allowing additional mappings if desired.

The setup interface 300 may further comprise way for the user to map motions to various game expected hardware input events such as the “Game Buttons” shown in FIG. 3. For example, a user may assign a sensed “UP” motion of the motion sensing device 10 to correspond to an up arrow, or perhaps a specific function key on a conventional keyboard or joystick, so that when the motion sensing device 10 is raised up in an upwardly direction, the motion mapping system 100 may generate and transmit to the computer's 80 operating system 98 a hardware input event equivalent as if the user had typed the up arrow (or the specific function key) on a keyboard. In another example, a user may desire a sensed “LEFT” motion to correspond to swinging a baseball bat in a PC baseball game, such as a right mouse click to swing the bat. Here, the setup interface 300 may allow the user to map the sensed “Left” motion so that when a Left motion of the motion sensing device 10 is sensed, the microprocessor 50 of the motion mapping system 100 may generate and transmit to the computer's 80 operating system 98 a hardware input event equivalent as if the user had performed a right click on a mouse. In still another example, a tennis game may require a press of the “ctrl” key to perform a serve of the tennis ball. In this example, a user may prefer to use the setup interface 300 to map a downward swing of the motion sensing device 10 and thus a downward motion may result in the generation of a hardware input event equivalent as if the user had pressed the “ctrl” key. Obviously specific keys, mouse clicks, or mappings mentioned within this application are examples only and in no way are intended to cause any limitation to the claims or application.

Selections of items throughout the setup interface 300 may be in the form of a text input field but preferably draw upon a fixed universe of choices such as via a drop down box, radio buttons or the like where possible. In some embodiments, some motions of the motion sensing device 10 may be mapped to a plurality of hardware input events so that complex inputs to the game may be achieved with a single motion of the motion sensing device 10. For example, a Kungfu fighting game may require two or more standard inputs to perform a specific jump-and-kick move. In this example, without the motion mapping system 100, a user may be required to type in order the space bar followed by F6 (again, actual keys may vary), but the setup interface 300 may allow a single forward thrust of the motion sensing device 10 to be mapped to both the space bar and the F6 key such that upon sensing the forward thrust, the microprocessor 50 generates both the space bar and F6 key hardware events in order, and perhaps including defined timing between the two hardware input events.

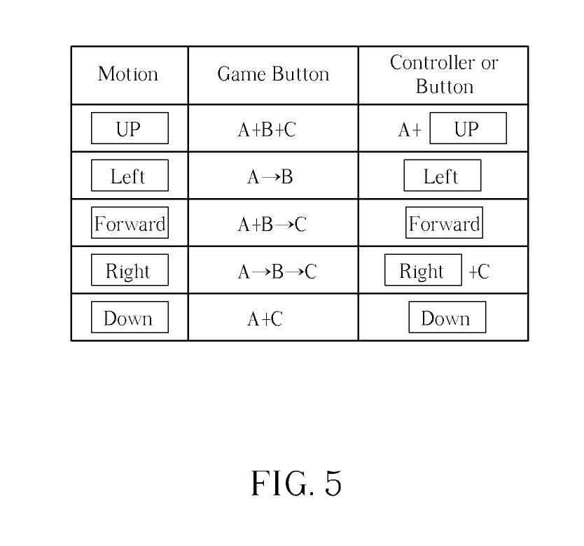

FIG. 5 is a diagram illustrating mapping examples according to other examples of the present invention. Referring to FIG. 5, upward motion (UP) of the motion sensing device 10 in this example may be mapped to correspond to simultaneously press game buttons (keys) “A,” “B,” and “C”. One so mapped, a player presses the “A” key while moving the motion sensing device 10 upward may result in generation of substantially simultaneous generation of hardware input events by the microcontroller 50 equivalent to a prior art simultaneous pressing of the “A,” “B,” and “C” keys. The second example maps a leftward motion (LEFT) of the motion sensing device 10 to be equivalent to the pressing of the “A” key followed by the “B” key after a predetermined (and possibly programmable via the setup interface 300) duration. The third example shows where a forward (FORWARD) motion of the motion sensing device 10 will result in the generation of hardware input events equating to simultaneous A and B key presses, followed by a press of the C key. The remaining examples should now be self explanatory.

A preferred embodiment of the motion mapping system 100 may include the motion sensing device 10 and the receiving device 40. The motion sensing device 10 may include the accelerometer 15, the rotational sensor 20, and the wireless version of the transmitter 30. The microprocessor 25 may be coupled to receive acceleration data from the accelerometer 15, to receive angular speed information from the rotational sensor 20, and to output corresponding motion data to the wireless transmitter 30. The receiving device may include a wireless receiver 45 coupled to output to a microprocessor 50 motion data received from the wireless transmitter 30. In the preferred embodiment, the receiving device 40 is a USB dongle and the microprocessor 50 is further coupled to a USB port of the dongle. A dongle is defined as a portable wireless device connectable to a computer allowing transmission and reception of signals by the computer via the portable wireless device.

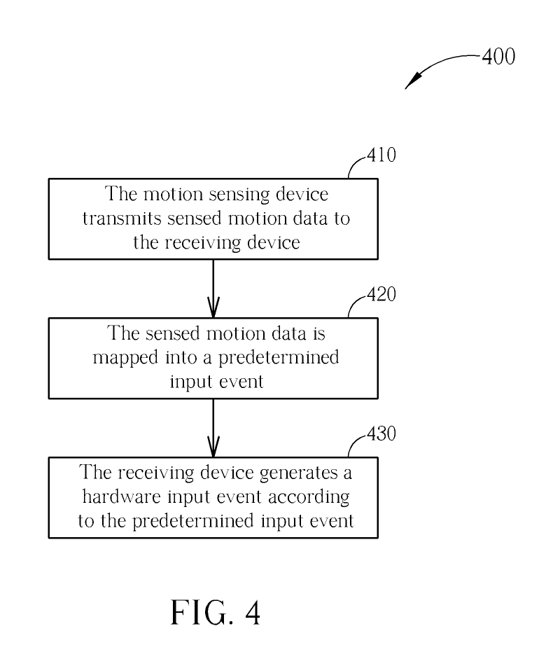

Operation of the preferred embodiment is depicted in the flowchart 400 in FIG. 4.

In step 410, motion data from the accelerometer 15 and the rotational sensor 20 via the microprocessor 25 may be transmitted by the wireless transmitter 30 to the wireless receiver 45 of the receiving device 40.

In step 420, the microprocessor 50 may receive the motion data from the wireless receiver 45 and transmit the motion data to the motion mapping software 95 via the USB port. The motion mapping software may determine the input event corresponding to the motion data and transmits a control signal indicating the corresponding input event back to the microprocessor 50 via the USB port of the dongle.

In step 430, the microprocessor 50 may generate a hardware input event of a type corresponding to the control signal and transmits the hardware input event back through the USB port to the operating system 98 of the computer 80.

The motion sensing systems disclosed herein provide the advantages of allowing a user's motions of a motion sensing device to be mapped to any required hardware input events and have the corresponding hardware input event generated for use within a computer. The mappings may be user defined and a single mapping may generate a plurality of hardware events, simplifying and enhancing a user's game playing experience.

Those skilled in the art will readily observe that numerous modifications and alterations of the device and method may be made while retaining the teachings of the invention.

What is claimed is:

1. A motion mapping system comprising:
a motion sensing device comprising:
an accelerometer for generating acceleration data;
a rotational sensor for generating angular speed data;
a wireless transmitter; and
a microprocessor coupled to receive the acceleration data, to receive the angular speed, and to output corresponding motion data to the wireless transmitter; and
a Universal Serial Bus dongle comprising:
a Universal Serial Bus port;
a wireless receiver for receiving the corresponding motion data from the wireless transmitter; and
a microprocessor coupled to receive the corresponding motion data from the wireless transmitter, for outputting the corresponding motion data via the Universal Serial Bus port to a mapping software, for receiving from the mapping software a control signal indicating an input event according to the corresponding motion data, and for generating and outputting via the Universal Serial Bus port a hardware input event corresponding to the input event.

2. The motion mapping system of claim 1 further comprising a computer connected to the Universal Serial Bus port, the computer comprising a CPU and a memory storing the mapping software and an operating system, the mapping software being executed by a CPU to generate the control signal and the operating system being executed by the CPU to receive the hardware input event.

3. A method of operating a motion sensing system, the motion control system comprising:
a wireless motion sensing device comprising a motion sensor;
a wireless receiver comprising a microprocessor; and
a computer storing a mapping software;
the method comprising:
transmitting motion data from the wireless motion sensing device to the wireless receiver;
the wireless receiver transmitting the motion data to the mapping software;
the mapping software mapping the motion data to a predetermined input event;
the mapping software transmitting a control signal indicating the predetermined input event to the microprocessor; and
the microprocessor generating and transmitting a hardware input event to the computer according to the control signal.

4. The method of claim 3 further comprising the wireless receiver transmitting the motion data to the mapping software via a Universal Serial Bus interface.

5. The method of claim 4 further comprising the mapping software transmitting the control signal indicating the predetermined input event to the microprocessor via the Universal Serial Bus interface and the microprocessor transmitting the hardware input event to the computer via the Universal Serial Bus interface.

6. The motion mapping system of claim 3 further comprising mapping motion data to input event according to user preferences.

7. The motion mapping system of claim 3 further comprising mapping a single recognizable motion from the motion data to a plurality of corresponding input events and generating a plurality of corresponding hardware input events in response to the single recognizable motion.

8. A motion mapping system comprising:
a wireless motion sensing device including an accelerometer for sensing acceleration of the motion sensing device and a rotational sensor for sensing angular speed of the motion sensing device; and
a wireless receiving device for receiving motion data transmitted from the motion sensing device, and for generating a hardware input event in response to a control signal from a mapping software indicating the hardware input event corresponding to the motion data.

9. The motion mapping system of claim 8 wherein the wireless motion sensing device further comprises a microprocessor for determining the motion data according to the sensed acceleration and angular speed of the motion sensing device.

10. The motion mapping system of claim 9 wherein the wireless receiving device is a dongle having a Universal Serial Bus port.

11. The motion mapping system of claim 10 wherein the wireless receiving device further comprises a microprocessor for transmitting via the Universal Serial Bus port motion data from the motion sensing device to the mapping software and for generating and transmitting via the Universal Serial Bus port the hardware input event in response to the control signal from the mapping software.

12. The motion mapping system of claim 8 wherein the wireless receiving device is a dongle having Universal Serial Bus port and further comprises a microprocessor for transmitting via the Universal Serial Bus port motion data from the motion sensing device to the mapping software and for generating and transmitting via the Universal Serial Bus port the hardware input event in response to the control signal from the mapping software.
